(19) United States
(12) Patent Application Publication
(10) Pub. No.: US 2024/0260619 A1
(43) Pub. Date: Aug. 8, 2024

(54) PASTA FORM, DEVICE, ASSEMBLY, AND METHOD

(71) Applicant: SPORKFUL LLC, Greenlawn, NY (US)

(72) Inventor: Daniel Pashman

(73) Assignee: SPORKFUL LLC, Greenlawn, NY (US)

(21) Appl. No.: 18/290,192

(22) PCT Filed: May 12, 2022
(86) PCT No.: PCT/US22/28908

§ 371 Date: Nov. 10, 2023

Related U.S. Application Data
(60) Provisional application No. 63/187,482, filed on May 12, 2021.

(51) Int. Cl. A23L 7/109

(52) U.S. Cl. CPC A23L 7/109

(57) ABSTRACT

An extruded pasta form device and assembly. In one embodiment, the device comprises an elongated base strip and a pair of parallel longitudinally extending ruffle fins. The result is a hybrid device having a substantially right angle intersection a the ruffle fins and base strip for bite resistance about a plurality of angles.

This application claims priority to U.S. Provisional Application No. 63/187,482, filed May 12, 2021, which is incorporated herein by reference in its entirety.

### FIELD

The present disclosure relates generally to food stuffs and, more particularly, to a pasta form, system, and assembly.

### BACKGROUND

Various known pastas are prepared, packaged, modified by mixing together ingredients to give a particular pasta a shape, taste, color, consistency, etc. However, traditional pasta forms, including, but not limited to, shape, fail to provide enhanced dynamic contrast, sauceability, forkability, alone or in combination, and the like.

Therefore, Applicant desires a device and method for improved performance without the drawbacks presented by the traditional systems and methods.

### BRIEF DESCRIPTION OF THE DRAWINGS

Embodiments of the disclosure will be better understood by a reading of the Description of Embodiments along with a review of the drawings, in which:

FIG. 1 is a top perspective view of a device according to one embodiment of the disclosure;

FIG. 2 is a top perspective view of a device according to one embodiment of the disclosure;

FIG. 2a is an isolated, top perspective view of the device according to FIG. 2, with elements removed for clarity;

FIG. 2b is an isolated, top perspective view of the device according to FIG. 2, with elements removed for clarity;

FIG. 3 is a top perspective view of a device according to one embodiment of the disclosure;

FIG. 3a is a top perspective view of a device according to one embodiment of the disclosure;

FIG. 3b is a top perspective view of a device according to one embodiment of the disclosure;

FIG. 4 is a side perspective view of the device according to at least FIG. 1;

FIG. 4b is an isolated, front perspective view of the device according to FIG. 4, with elements removed for clarity;

FIG. 5 is a side perspective view of the device according to at least FIG. 1;

FIG. 5a is a side perspective view of a device according to one embodiment of the disclosure introduced in FIG. 3a; and

FIG. 5b is a side perspective view of a device according to one embodiment of the disclosure introduced in FIG. 3b.

### SUMMARY

Applicant desires a device, system, assembly, and method of preparation without the drawbacks presented by the traditional systems and methods. Those skilled in the art having the benefit of this disclosure will recognize additional features, advantages over conventional systems, and improvements for device forms and the like.

In accordance with the present inventions, Applicant's device and assembly provide enhanced dynamic contrast and textural variations between opposing elements shown and described herein. These inventions provide an improved device and form that is convenient, efficient, and safe for the user, particularly for any of the enhanced sauceability, forkability, and toothsinkability shown and described herein.

In one embodiment, a pasta shape comprises an elongated base strip; a half tube recessed within the elongated base strip; and a pair of opposing longitudinally extending elements being offset from an outer edge of the elongated base strip and the half tube, and wherein at least two of the elongated base strip, half tube, and longitudinally extending elements perpendicularly intersect.

In one embodiment, an extruded pasta form comprises a pair of opposing ruffle fins; a substantially half tube; and an elongated strip having an upper surface aligned between the half tube and the ruffle fins.

In certain examples, the opposing ruffle fins and half tube define a sauce trough. The upper surface may include at least a portion of a substantially flat upper surface and a substantially flat bottom surface substantially parallel about the upper surface. The ruffle fins may include a concave portion. The ruffle fins may include a convex portion. The pair of ruffle fins may extend substantially greater than a length of the elongated base strip. The ruffle fins may include a height greater than a height of the elongated base strip. The pasta may include a partial tube recessed about the elongated base strip. The pasta may include a textural variation at the elongated base strip.

In one embodiment, a pasta form comprises an elongated base strip; and a pair of parallel longitudinally extending ruffle fins aligned substantially perpendicular about the strip, and wherein a substantially right angle intersection of the ruffle fins about the base strip defines a bite resistance about a plurality of angles, and the pasta form adapted to be an extruded pasta.

In certain examples, the device may include a half tube recessed about the elongated base strip. The elongated base strip may include at least a portion of a substantially flat upper surface. The elongated base strip may include a substantially flat bottom surface. The pair of parallel longitudinally extending ruffle fins may oppose one another. The pair of parallel longitudinally extending ruffle fins may extend substantially along a length of the elongated base strip.

In particular examples, the elongated base strip may include a ledge opposite at least one longitudinally extending ruffle fin. The elongated base strip may include two ledges opposite the pair of respective longitudinally extending ruffle fins having a distal surface and proximate surface, and wherein the proximate surface spaced apart from the distal surface defining at least one sauce trough. The device may include a tube recessed about the elongated base strip. The tube may include a continuous internal longitudinal cavity.

In one embodiment, a pasta shape comprises an elongated base strip; a half tube recessed within the elongated base strip; and a pair of opposing longitudinally extending ruffles offset from an outer edge of the elongated base strip and the half tube.

In certain examples, the pasta shape is an extruded pasta. The elongated base strip may include at least a portion of a substantially flat upper surface. The elongated base strip may include a substantially flat bottom surface. The substantially flat bottom surface may be aligned substantially parallel about the upper surface. The longitudinally extending ruffle fins may include a concave portion. The longitudinally extending ruffle fins may include a convex portion. The pair of opposing longitudinally extending ruffle fins may oppose one another. The pair of opposing longitudinally extending ruffle fins may extend substantially along a length of the elongated base strip. The pair of opposing longitudinally extending ruffle fins may extend substantially less than a length of the elongated base strip. The pair of opposing longitudinally extending ruffle fins may extend substantially greater than a length of the elongated base strip.

In some examples, the longitudinally extending ruffle fins include a height greater than a height of the elongated base strip. The elongated base strip may include a ledge opposite at least one longitudinally extending ruffle fin. The elongated base strip may include two ledges opposite the pair of respective longitudinally extending ruffle fins. The longitudinally extending ruffle fins may include a distal surface. The elongated base strip may include a proximate surface. The proximate surface may be spaced from the distal surface. The spacing may define at least one sauce trough. The elongated base strip may include a textured surface. The textured surface may include a rough surface.

In certain examples, the tube may include a continuous internal longitudinal cavity. The continuous internal longitudinal cavity may communicate with the pair of opposing longitudinally extending ruffle fins to define a sauce trough. The form may include a dough. The dough may include enriched durum semolina flour, iron, niacin, thiamine, riboflavin, and folic acid, or the like.

In particular examples, the form comprises a plurality of textural variations. The textural variation at the elongated base strip may be distinct from a textural variation at the longitudinally extending ruffle fins. The textural variation at the half tube strip may be distinct from a textural variation at the longitudinally extending ruffle fins. The device may include any unique sauceability shown and described herein. The device may include any unique forkability shown and described herein. The device may include any unique toothsinkability shown and described herein. Further, the device may include any unique dynamic contrast shown and described herein.

In one embodiment, a pasta form comprises an elongated base strip; and a pair of parallel longitudinally extending ruffle fins aligned substantially perpendicular about the strip, and wherein a substantially right angle intersection of the ruffle fins about the base strip defines a bite resistance about a plurality of angles, and the pasta form adapted to be an extruded pasta.

In certain examples, the device includes a half tube recessed about the elongated base strip. The elongated base strip may include at least a portion of a substantially flat upper surface. The elongated base strip may include a substantially flat bottom surface. The substantially flat bottom surface may be aligned substantially parallel about the upper surface. The longitudinally extending ruffle fins may include a concave portion. The longitudinally extending ruffle fins having a convex portion. The pair of parallel longitudinally extending ruffle fins may oppose one another. The pair of parallel longitudinally extending ruffle fins may extend substantially along a length of the elongated base strip. The pair of parallel longitudinally extending ruffle fins may extend substantially less than a length of the elongated base strip.

In some examples, the pair of parallel longitudinally extending ruffle fins extend substantially greater than a length of the elongated base strip. The longitudinally extending ruffle fins may include a height greater than a height of the elongated base strip. The elongated base strip may include a ledge opposite at least one longitudinally extending ruffle fin. The elongated base strip may include two ledges opposite the pair of respective longitudinally extending ruffle fins. The longitudinally extending ruffle fins may include a distal surface. The elongated base strip may include a proximate surface. The proximate surface may be spaced from the distal surface. The spacing may define at least one sauce trough. The elongated base strip may include a textured surface, for instance a rough or similar surface.

In certain examples, the tube may include a continuous internal longitudinal cavity. The continuous internal longitudinal cavity may communicate with the pair of opposing longitudinally extending ruffle fins to define a sauce trough. The form may include a dough. The dough may include enriched durum semolina flour, iron, niacin, thiamine, riboflavin, and folic acid, or the like.

In particular examples, the form comprises a plurality of textural variations. The textural variation at the elongated base strip may be distinct from a textural variation at the longitudinally extending ruffle fins. The textural variation at the half tube strip may be distinct from a textural variation at the longitudinally extending ruffle fins. The device may include any unique sauceability shown and described herein. The device may include any unique forkability shown and described herein. The device may include any unique toothsinkability shown and described herein. Further, the device may include any unique dynamic contrast shown and described herein.

In one embodiment, an extruded pasta form comprises a pair of opposing ruffle fins; a substantially tube; and an elongated strip having an upper surface aligned between the tube and the ruffle fins.

In certain examples, the elongated base strip may include at least a portion of a substantially flat upper surface. The elongated base strip may include a substantially flat bottom surface. The substantially flat bottom surface may be aligned substantially parallel about the upper surface. The longitudinally extending ruffle fins may include a concave portion. The longitudinally extending ruffle fins having a convex portion. The pair of parallel longitudinally extending ruffle fins may oppose one another. The pair of parallel longitudinally extending ruffle fins may extend substantially along a length of the elongated base strip. The pair of parallel longitudinally extending ruffle fins may extend substantially less than a length of the elongated base strip.

In some examples, the pair of parallel longitudinally extending ruffle fins extend substantially greater than a length of the elongated base strip. The longitudinally extending ruffle fins may include a height greater than a height of the elongated base strip. The elongated base strip may include a ledge opposite at least one longitudinally extending ruffle fin. The elongated base strip may include two ledges opposite the pair of respective longitudinally extending ruffle fins. The longitudinally extending ruffle fins may include a distal surface. The elongated base strip may include a proximate surface. The proximate surface may be spaced from the distal surface. The spacing may define at least one sauce trough. The elongated base strip may include a textured surface, for instance a rough or similar surface.

In certain examples, the tube may include a continuous internal longitudinal cavity. The continuous internal longitudinal cavity may communicate with the pair of opposing longitudinally extending ruffle fins to define a sauce trough. The form may include a dough. The dough may include enriched durum semolina flour, iron, niacin, thiamine, riboflavin, and folic acid, or the like.

In particular examples, the form comprises a plurality of textural variations. The textural variation at the elongated base strip may be distinct from a textural variation at the longitudinally extending ruffle fins. The textural variation at the half tube strip may be distinct from a textural variation at the longitudinally extending ruffle fins. The device may include any unique sauceability shown and described herein. The device may include any unique forkability shown and described herein. The device may include any unique toothsinkability shown and described herein. Similarly, the device may include any unique dynamic contrast shown and described herein.

In one embodiment, a device for extruding a pasta form comprises an elongated base strip; and a pair of parallel longitudinally extending ruffle fins aligned substantially perpendicular about the strip.

In one embodiment, a device for extruding a pasta form comprises a pair of opposing ruffle fins; a substantially half tube; and an elongated strip having an upper surface aligned between the half tube and the ruffle fins.

In one embodiment, a device for extruding a pasta form comprises an elongated base strip; a half tube recessed within the elongated base strip; and a pair of opposing longitudinally extending ruffles offset from an outer edge of the elongated base strip and the half tube.

The above summary was intended to summarize certain embodiments of the present disclosure. Embodiments will be set forth in more detail in the figures and description of embodiments below. It will be apparent, however, that the description of embodiments is not intended to limit the present inventions, the scope of which should be properly determined by the appended claims.

### DETAILED DESCRIPTION

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

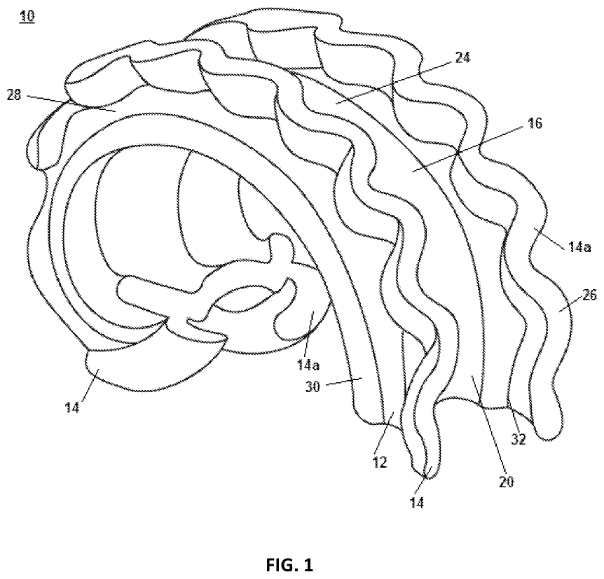

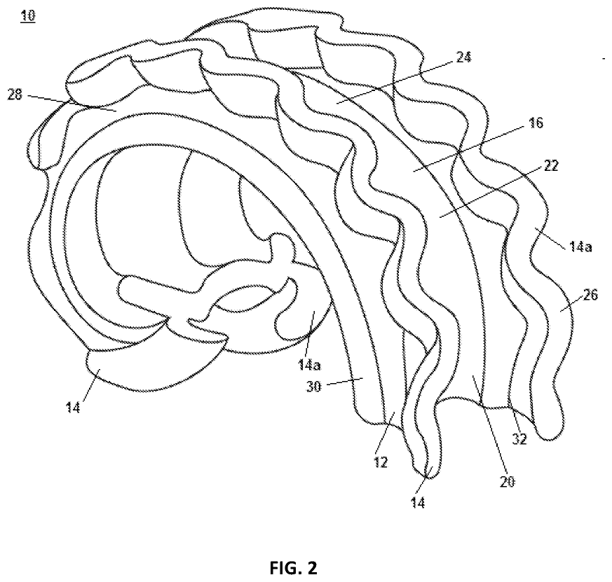

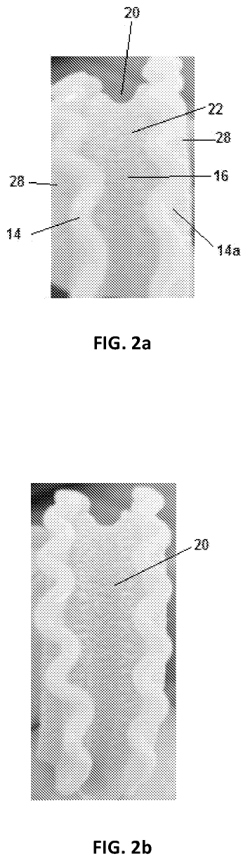

Referring now to the drawings in general and FIGS. 1-3b in particular, it will be understood that the illustrations are for the purpose of describing embodiments of the disclosure and are not intended to limit the disclosure or any inventions thereto. As best seen in FIGS. 1-5b, the form device 10 provides enhanced dynamic contrast and textural variations between opposing elements. As shown, Applicant has unexpectedly discovered the device 10 creates and maintains bite resistance about a plurality of angles, as well as unforeseen advantages of enhanced sauceability, forkability, and toothsinkability shown and described herein. Those skilled in the art having the benefit of this disclosure will recognize additional element ratio relationships, dimensions, including but not limited to predetermined length segments and width alternatives, orientations, materials, and arrangement of elements.

As shown in FIG. 1, a pasta form 10 may have a pair of opposing ruffle fins 14, 14a; a substantially half tube 16; and an elongated strip 12. As illustrated, the pasta form 10 may have an upper surface aligned between the half tube and the ruffle fins to provide any of the benefits and improvements herein.

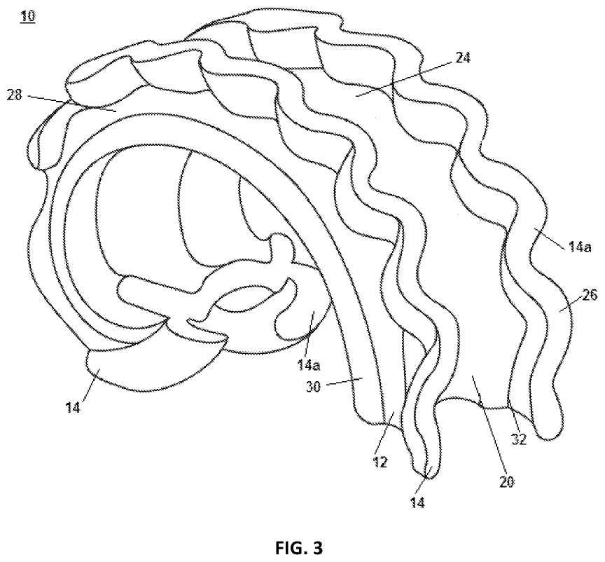

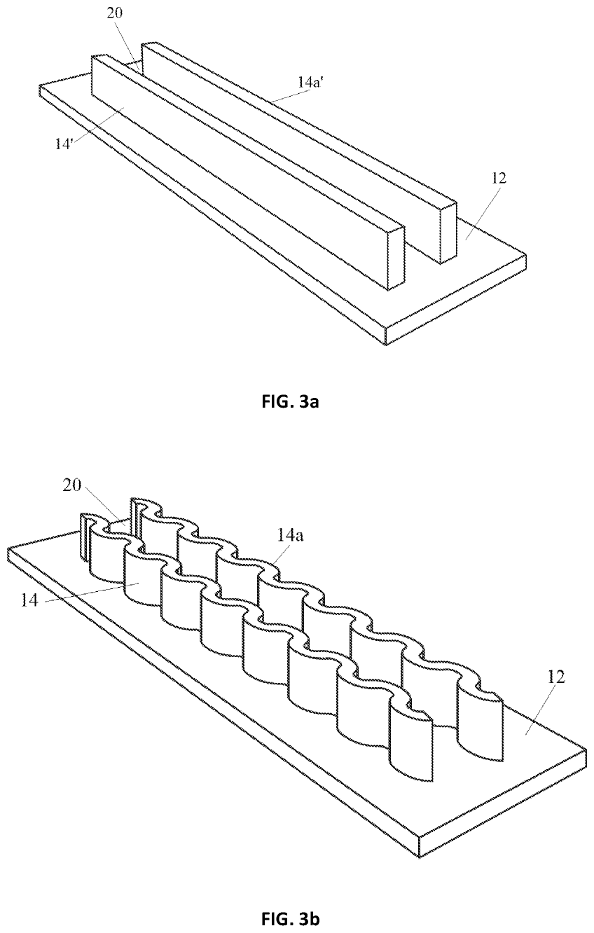

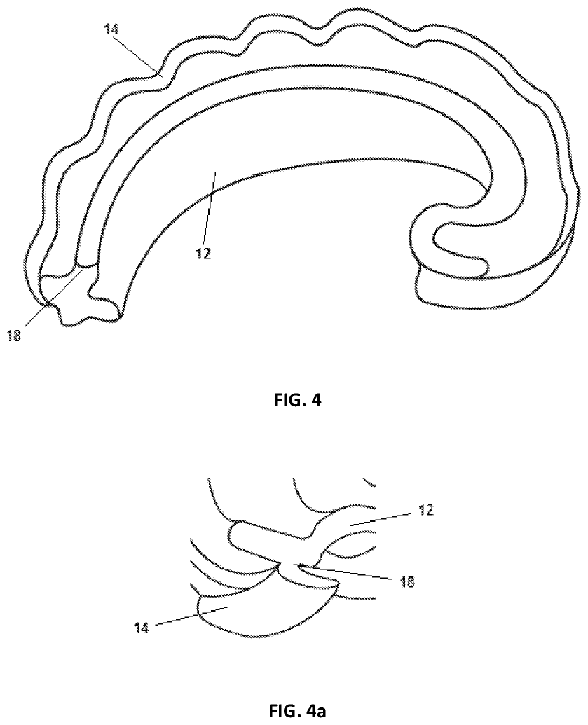

As shown in FIG. 3, an alternative pasta form 10 may have an elongated base strip 12; and a pair of parallel longitudinally extending ruffle fins 14, 14a aligned substantially perpendicular about the strip 12, and wherein a substantially right angle intersection 18 (also shown in FIG. 4a) of the ruffle fins 14, 14a about the base strip 12 defines a bite resistance about a plurality of angles. Further, as shown in FIGS. 3a and 3b, and later in 5a and 5b, alterative pasta forms 10 include a combination of fins 14, 14′, 14a, 14a′ aligned about base strip 12, for instance with or without additional elements, to provide any of the unexpected advantages taught and shown herein, including, but not limited to, enhanced sauceability in the sauce troughs, bite resistance about a plurality of angles, and the like.

In certain examples, the elongated base strip 12 may include at least a portion of a substantially flat upper surface. Further, the elongated base strip 12 may include a substantially flat bottom surface. The substantially flat bottom surface may be aligned substantially parallel about the upper surface. The longitudinally extending ruffle fins 14, 14a may include a concave portion, a convex portion, any wave or similar form, a combination thereof, and the like. As illustrated, the pair of parallel longitudinally extending ruffle fins 14, 14a may oppose one another. The pair of parallel longitudinally extending ruffle fins 14, 14a may extend substantially along a length of the elongated base strip 12. While in alternative examples, the pair of parallel longitudinally extending ruffle fins 14, 14a may extend substantially less than, or greater than, a length of the elongated base strip 12. Those skilled in the art having the benefit of this disclosure will recognize additional fin and strip orientations and dimensions.

In some examples, the longitudinally extending ruffle fins 14, 14a may include a height that is generally greater than a height (including width) of the elongated base strip. The elongated base strip 12 may include a ledge 28 opposite at least one longitudinally extending ruffle fin 14, 14a. The elongated base strip 12 may include two ledges 28 opposite the pair of respective longitudinally extending ruffle fins 14, 14a. The longitudinally extending ruffle fins 14, 14a may include a distal surface 26. The elongated base strip 12 may include a proximate surface 24. Thereby the proximate surface 24 may be spaced from the distal surface 26, for instance to define at least one sauce trough 20. The elongated base strip 12 may include a textured surface 22, for instance a rough or similar surface.

In certain examples, the tube 16 may include a continuous (including semi-continuous) internal longitudinal cavity. The continuous internal longitudinal cavity may communicate with the pair of opposing longitudinally extending ruffle fins 14, 14a to define any sauce trough 20 shown and described herein.

The form may be extruded in a variety of ways and comprise a variety of doughs. In one particular example, the dough may include enriched durum semolina flour, iron, niacin, thiamine, riboflavin, and folic acid, or the like. Those skilled in the art having the benefit of this disclosure will recognize additional doughs and the like within the spirt of these inventions.

In certain embodiments, a depth of the half tube in a dry condition may range from about 0.02 inches to about 0.1 inches, including, but not limited to, from about 0.052 inches to about 0.067 inches. While other embodiments and examples within the spirt of these inventions include a variety of additional depths, sizes, and dimensions.

In certain embodiments, any of the dynamic contrast shown and described herein may include any moment-to-moment sensory contrast from the ever-changing properties of foods manipulated in the mouth, or the like, for instance as taught in Hyde R J, Witherly S A. Dynamic contrast: A Sensory Contribution to Palatability. Appetite. 1993 August; 21(1): 1-16. doi: 10.1006/appe. 1993.1032. PMID: 8239631, the teachings of which that are consistent herein are incorporated by reference in their entirety. Further, the examples and embodiments herein of a single bite may provide a variety of sensations of dynamic contrast shown and described herein. For instance, the examples and embodiments herein may include wide ranges of textures and bite force, including: full shape embodiment 170 work, gcm (gram centimeters); flat strip and half tube, no ruffles 128 work, gcm; isolated two ruffles 20 work, gcm; half tube 62 work, gcm; and isolated outer edges 44 work, gcm. Other embodiments and examples within the spirt of these inventions include a variety of additional dynamic contrast, bite force, and dimensions.

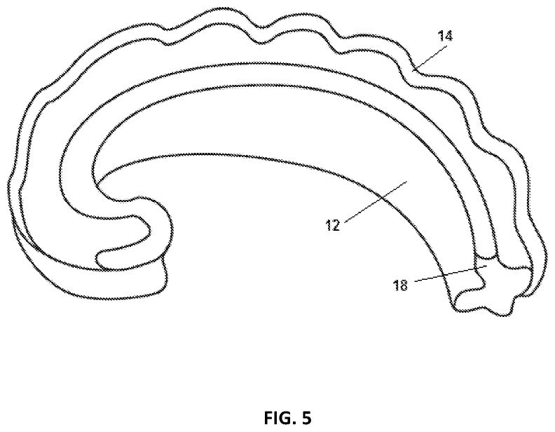

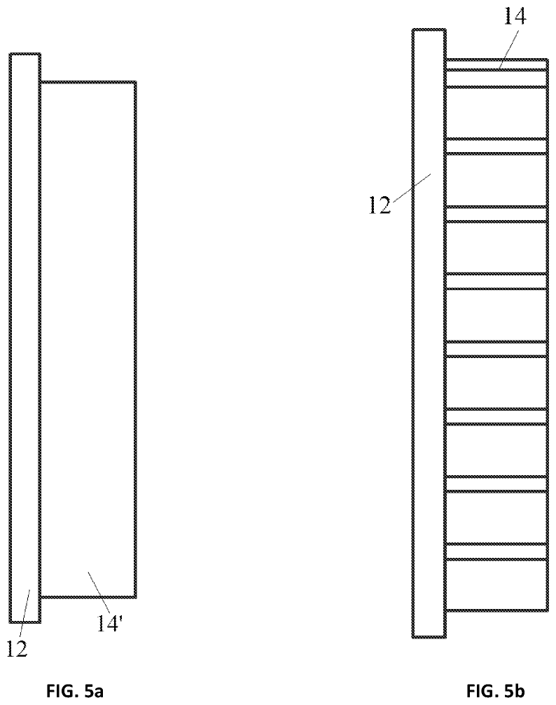

In alternative embodiments, for instance as introduced in FIGS. 3a, 3b, 5a, 5b, any of the inventions herein may include any of the side-by-side strands shown and described herein attached together, for instance perpendicular a third strand for any of the improvements touted herein, including, but not limited, to sauceability. In any of these examples and embodiments, one or more, including two, strips may be ruffled, textured, not ruffled, not textured, or the like. Further, any of these examples and embodiments may include consistent length strips and inconsistent length strips, including offset, or otherwise varying, length segments. Other embodiments and examples within the spirt of these inventions include a variety of arrangement of elements, sizes, dimensions, combinations, and the like.

In other embodiments, the disclosure includes a pasta kit. In such an embodiment, the kit may comprise a structure to prepare a form device 10, e.g. any of the form shape elements and components previously shown or described. Further, other embodiments of the kit may include dough, e.g. any dough elements and components previously shown or described.

Numerous characteristics and advantages have been set forth in the foregoing description, together with details of structure and function. Many of the novel features are pointed out in the appended example claims. The disclosure, however, is illustrative only, and changes may be made in detail, especially in matters of shape, size and arrangement of parts, within the principle of the disclosure, to the full extent indicated by the broad general meaning of the terms in which the general claims are expressed. It is further noted that, as used in this application, the singular forms “a,” “an,” and “the” include plural referents unless expressly and unequivocally limited to one referent.

What is claimed is:

1. A pasta form comprising:
a. an elongated base strip; and
b. a pair of parallel longitudinally extending ruffle fins aligned substantially perpendicular about said strip, and
wherein a substantially right angle intersection of said ruffle fins about said base strip defines a bite resistance about a plurality of angles, and said pasta form adapted to be an extruded pasta.

2. The device of claim 1, including a half tube recessed about said elongated base strip.

3. The device of claim 2, wherein said elongated base strip comprises at least a portion of a substantially flat upper surface.

4. The device of claim 3, wherein said elongated base strip comprises a substantially flat bottom surface.

5. The device of claim 1, wherein said pair of parallel longitudinally extending ruffle fins oppose one another.

6. The device of claim 1, wherein said pair of parallel longitudinally extending ruffle fins extend substantially along a length of said elongated base strip.

7. The device of claim 1, wherein said elongated base strip includes a ledge opposite at least one longitudinally extending ruffle fin.

8. The device of claim 7, wherein said elongated base strip includes two ledges opposite said pair of respective longitudinally extending ruffle fins having a distal surface and proximate surface, and wherein said proximate surface spaced apart from said distal surface defining at least one sauce trough.

9. The device of claim 1, including a tube recessed about said elongated base strip.

10. The device of claim 9, wherein said tube comprising a continuous internal longitudinal cavity.

11. An extruded pasta form comprising:
a. a pair of opposing ruffle fins;
b. a substantially half tube; and
c. an elongated strip having an upper surface aligned between said half tube and said ruffle fins.

12. The extruded pasta of claim 11, wherein said opposing ruffle fins and said half tube define a sauce trough.

13. The extruded pasta of claim 11, wherein said upper surface comprises at least a portion of a substantially flat upper surface and a substantially flat bottom surface substantially parallel about said upper surface.

14. The extruded pasta of claim 11, wherein said ruffle fins having a concave portion.

15. The extruded pasta of claim 11, wherein said ruffle fins having a convex portion.

16. The extruded pasta of claim 11, wherein said pair of ruffle fins extend substantially greater than a length of said elongated base strip.

17. The extruded pasta of claim 11, wherein said ruffle fins include a height greater than a height of said elongated base strip.

18. The extruded pasta of claim 11, including a partial tube recessed about said elongated base strip.

19. The extruded pasta of claim 11, including a textural variation at said elongated base strip distinct from a textural variation at said ruffle fins.

20. A pasta shape comprising:
a. an elongated base strip;
b. a half tube recessed within said elongated base strip and comprising a continuous internal longitudinal cavity; and
c. a pair of opposing longitudinally extending elements offset from an outer edge of said elongated base strip and said half tube, and
wherein at least two of said elongated base strip, half tube, and longitudinally extending elements perpendicularly intersect.
